(19) United States
(12) Patent Application Publication
(10) Pub. No.: US 2009/0305537 A1
(43) Pub. Date: Dec. 10, 2009

(54) Electrical Safety Socket Device

(76) Inventor: Francisco Esposito, Sao Paulo (BR)

Correspondence Address: CAHN & SAMUELS LLP, 1100 17th STREET NW, SUITE 401, WASHINGTON, DC, 20036, US

(21) Appl. No.: 12/296,567

(22) PCT Filed: Apr. 10, 2007
(86) PCT No.: PCT/BR2007/000090

§ 371 Date: Aug. 3, 2009

(30) Foreign Application Priority Data
Apr. 11, 2006 (BR) PI0602276-6

(51) Int. Cl. H01R 13/00

(52) U.S. Cl. 439/188

(57) ABSTRACT

In invention relates to an electrical safety socket device for connecting appliances and devices to an electrical power line which prevents the occurrence of electric shocks thereby protecting the user by an inadvertent finger touch with the prongs of a plug or by a single-pole insertion. The electrical safety socket device comprises a plug receiving member (1) with means for establishing respective electrical conduction and non conduction states.

### FIELD OF THE INVENTION

The invention relates to electrical sockets for connecting appliances and devices to an electrical power line, more particularly to an electrical safety socket device which prevents the occurrence of electric shocks that inadvertently may arise.

### BACKGROUND OF THE INVENTION

Among possible causes of electric shock occurrences with electrical socket devices of the state of art the most typical ones are related to an inadvertent finger touch or an object coming into contact with the prong(s) of the appliance plug partially plugged or when unplugging the same from an electrical socket device or even during a single-pole insertion of the plug.

There are known in the state of the art power outlet sockets containing safety arrangements in an attempt to minimize or to eliminate the risk of electric shocks when sections of prongs of an appliance plug are exposed during insertion in the electric power outlet carrying alternating current from the power source.

The proposals of the state of the art imply in additional components and have led to both sensible constructive adaptations and to an undesired change of the habit of simply plugging an appliance plug to an electrical socket device.

By way of example, BR Patent Application 9404524-0 discloses an electrical socket device with a rotational disk which is mounted externally on the front side of the outlet socket thereby covering the apertures of the electrical socket device against the insertion of the prongs or blades of a plug. The rotational disk is provided with apertures that are identical to the apertures on the outlet and is biased by a spring force to a mutual misalignment of the apertures when the electrical socket device is not used. For connecting an appliance plug to the electrical socket device the rotational disk must be turned until both sets of apertures are in alignment thereby enabling the insertion of the prongs or blades of the appliance plug into the apertures of the outlet socket.

Depending on the effort that is required to turn the disk to overcome the force that biases the disk to the closed position, it may be necessary the use of the other hand to turn the disk to uncover the apertures on the electrical socket device while the first hand urges the appliance plug into the outlet socket. The repetitive rotation of the disk against the spring force that holds the disk in close position will later or sooner wear or shift the center of the bearing of the axle of rotation of the disk located in the casing of the outlet socket and lead to a defective operation of the assembly. Additional costs in materials for the production of this outlet of inferior useful life are also expected.

Other proposals of the state of the art follow almost the same reasoning as it can be seen in BRPI9500696-6, BRPI9504283-0 and BRPI9706106-9 patent publications directed to electrical socket devices with apertures for accepting the prongs covered by an external sliding plate located on the front plate of the outlet or, conversely, as shown in BR PI9403156 and BR MU 7102005 publications, on the rear side thereof, the sliding plate of respective publications being provided with apertures that are identical to the apertures on the casing of the electrical socket device for the prongs of a plug. Besides the aforementioned additional materials related disadvantages these new proposals show a further disadvantage related to space limitations at both opposite lateral sides of the electrical socket device.

Another approach is disclosed in BRMU7402057-9 of 28/11/94 which refers to a safety device which is pivotally coupled to an electrical socket device comprising two pairs of covering members of identical shape 11, 11′. Both the pairs of closing members are housed in the casing of an electrical socket device 1 moving in scissor fashioned manner covering and uncovering the apertures 4 of the outlet socket. Said two pairs of members 11, 11′ form an assembly which is articulated by respective ring-shaped central portions 12,12′ adapted to rotate around an axle 20 located in a middle point between apertures 4. Each pair of articulated covering members comprises a distal planar portion 13, 13′ extending from the central portions 12,12′, said planar portions 13,13′ comprising respective an inclined region of surface 14,14′ that mutually converge to form a common edge adjacent to both regions of surface 14, 14′ when in normal closed position biased by springs 17 thereby covering a respective one aperture 4 of the electrical socket device. Upon abutment of prongs 3 of the appliance plug with the regions of surfaces 14, 14′ the distal planar portions 13, 13′ articulated by axle 20 are mutually moved away against the biasing force of return springs 17, 17′ thereby uncovering the pair of apertures 4 of the electrical socket device for receiving contacts 3. When only one of the pairs of distal planar portions 13, 13 is pressed or urged by an object that has been inserted by accident, e.g. a child playing with the apertures, closing members 11,11′ oscillate and stop against axle 20 and keep apertures 4 closed thereby preventing access to electrical contacts 2. The construction is rather complex and bearing portions are prone to wear out.

Other attempts of the state of the art have followed the same reasoning as disclosed in BRPI9605721-1 of 27/11/1996 claiming priority IT MI96A001630 of 30/07/1996, entitled “Blocking device for closing cavities of an electrical socket device”. The exploded view of 3 Fig. and the summary disclose a blocking device 306 intended to close the cavities of an electrical socket device 300 comprising an aperture for a live contact 316 and an aperture for a neutral contact 318 on a front plate 314. The blocking device 306 comprises a blocking portion 352 that moves between a rest position, in which live contact apertures 316 and neutral contact apertures 318 are closed, and a position which is operative, in which said apertures are open. The blocking portion 352 comprises two arms 356, 358 which rest against the live contact apertures 316 and the neutral contact aperture 318 when in the rest condition and in tilted position forming an angle with the direction of translation of the blocking portion 352. Again, a blocking assembly is provided moving upwards and downwards embodying the blocking portion 352, which upwardly slope is hit by the tip of the prong of an appliance plug and absorbs the impact causing arms 356 and 358 to move downwards thereby opening passages 342 and 344. This proposal represents a further development within the same concept of the electrical outlets of state of the art.

Another approach for a safety outlet is represented by BRPI9002593 of 31/05/90 claiming priority IT 21100-A/89, entitled “Safety device for sealing cavities of an electrical socket device” and BRMU7101389U of 24/06/91. BRPI9002593 discloses a safety device 1 for sealing cavities of an electrical socket device 2 which comprises a guided cover member 10 for sliding movement within the casing 3 against the force of a spring means 8 between the prongs 12 engaging portions 9 and the prongs engaging cavities located in the electrical socket device. The closing member 10 is housed within the outlet socket 2 in tilted relation with respect to a rear portion 27 of casing 3 and comprises two spaced apart surfaces 23, 24 in mutual opposed relation and delimiting a slight angle, means 25, 26 actuating in a portion of the closing member 10 preventing the same from sliding, said portion being pressed by one of the surfaces indicated with 23, 24.

Despite the different constructive elements in this latter electrical socket device, all the devices of which the applicant is aware follow the same reasoning which is focused on sealing or blocking the prongs engaging apertures on electrical sockets which communicate to the electric power line wired on the back side of the electrical socket device. The sole difference is that patent BRPI 9002993 teaches the use of a closing member 10 formed by respective pairs of upwardly oriented slopes 13, 14 on opposite portions 5, 6 which are urged to move away from each other thereby enabling the passage of prongs 12 of appliance plug 11 during their insertion upon abutment with distal portions of the upwards oriented slopes 13, 14. Summing up, as disclosed in the aforementioned publications of the state of the art, the electrical socket device comprise additional components closing apertures under biasing spring forces that act along a direction which is perpendicular to the direction of the insertion force.

### SUMMARY OF THE INVENTION

Diverging from the prior art examples, the main object of this invention is to provide an electrical safety socket device with electric shock protection which includes an appliance plug receiving member that is adapted to cooperate with an appliance plug connected thereto to commutate respective conduction and non conduction states between electric power line and appliance.

More specifically, the plug receiving member of the electrical socket device of the invention includes a set of prongs receiving apertures and is responsive to the back-and-forth movement of the appliance plug when fully inserted in the electrical socket device, thereby commutating to the conduction and a non-conduction states respectively.

The prongs receiving apertures and receiving member are defined by a protrusion area of the electrical socket device, with the known female electric contact elements on the rear side and an auxiliary member disposed therebetween, which are engaged by the pair of prongs of the appliance plug during the back-and-forth movement inside the socket device.

In the preferred embodiment the prongs receiving apertures are an integral part with the moveable receiving member of the electrical socket device. The prongs receiving apertures also can be formed by respective movable wall sections similar to single sleeves.

The conduction and non conduction states with the electric power line are obtained by a reciprocating movement of the centrally located prongs receiving member. According to the preferred embodiment the prongs receiving member is spring loaded or actuated by a resilient means for moving back and forth between a normal position with partial depth insertion of the prongs preventing an electrical conduction state and a final position with full depth insertion of the prongs commutating to conduction state.

By this way, an electric shock is prevented with partial depth insertion of the appliance plug, at an eventual insertion with one of the prongs, or with any other object in the prong receiving aperture.

The provision of a moveable plug receiving member in the outlet socket of the present invention as a transiting member between conduction and non-conduction states does not imply in any installation steps different from the already known ones having regard to the electrical socket devices of the state of the art or in major production costs, large number of additional members. Moreover, the outlet socket provides for the desired safety without changing the simple plugging and unplugging an appliance from power line.

As illustrated in figures and its description the electrical socket provides for a safe connection with a sensible minor wear and a durability which is longer than with the electrical protection sockets of the state of the art. This is due to the fact that both the pushing force impelling the plug with the receiving member to full insertion into the electrical socket and the reaction force opposing to said movement are in mutual alignment. There are no lateral or angular force components to overcome or that would interfere similar to those actuating on the blocking and covering members of the electrical safety socket devices of the state of the art.

### BRIEF DESCRIPTION OF FIGURES

Other features will become more apparent in the detailed description of the preferred embodiment with reference to the following figures, in which:

FIG. 1: is a perspective view of the electrical socket device of the invention and an appliance plug to be connected thereto in spaced apart relation;

FIG. 2: is an exploded view of the electrical socket device of FIG. 1;

FIG. 3: is a front view of the electrical socket device;

FIG. 4: is a cross-sectional view (section B-B, FIG. 3) of the electrical socket device;

FIG. 5: is a fragmentary cross-sectional view (section A-A, FIG. 3);

FIG. 6: is a cross-sectional view of the electrical socket device with an appliance plug received in the prongs receiving member in protruded position with partial depth insertion without electrical conduction;

FIG. 7: is a cross-sectional view of the electrical socket device with both the appliance plug, the prongs receiving member engaged by power line contacts when in full depth insertion, enabling electric conduction state;

FIG. 8: is an orthographic drawing showing initial, intermediate and final plugging of the appliance plug relative to power line contacts;

FIG. 9: is an orthographic drawing similar to FIG. 8 depicting an exemplary single pole introduction with one of the prongs of the appliance plug.

### DETAILED DESCRIPTION OF FIGURES

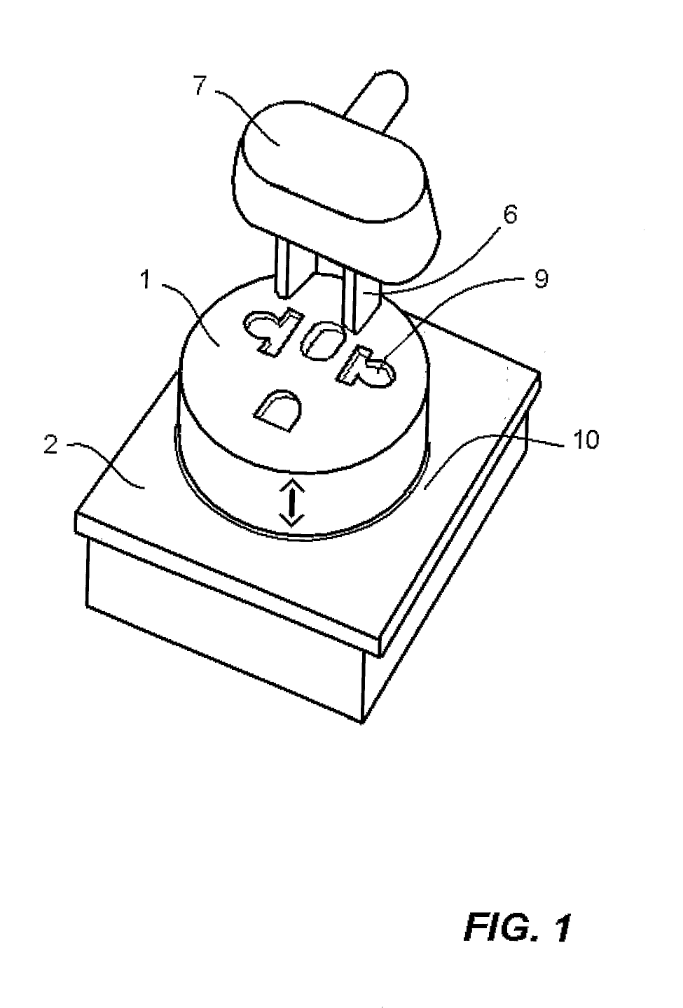

Referring to FIG. 1, the electrical socket device according to the preferred embodiment of the present invention is shown to comprise a prongs receiving member 1 which is centrally located and protrudes through an opening on front plate 2 and is a movable mounted inside the casing 5. A known distribution of prongs receiving apertures 9 for a corresponding appliance plug 7 is located on the prongs receiving member 1.

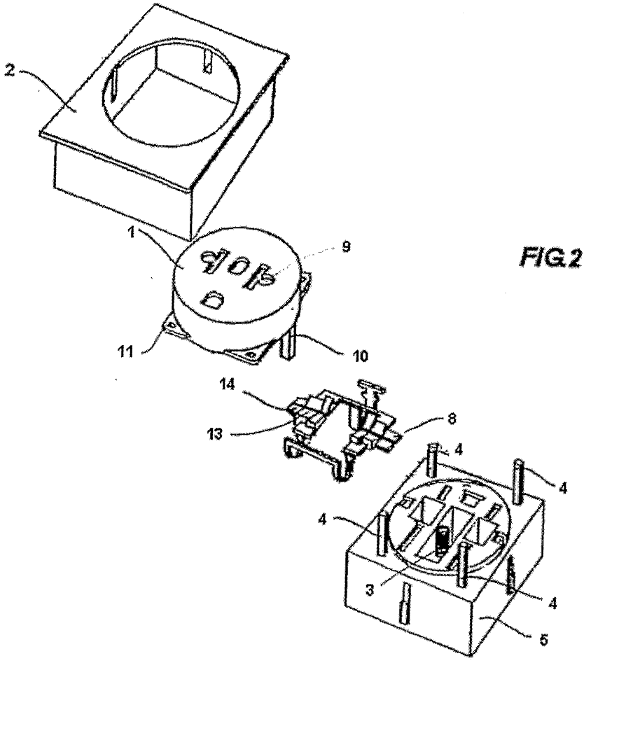

The main members of the electrical socket device are shown in the exploded view of FIG. 2 and comprise casing 2, the prongs receiving centrally located member 1, a base member 5, and an auxiliary barrier member 8 located therebetween. Base member 5 includes a plurality of cavities, fitting and guiding portions which are adapted to house the auxiliary barrier member 8, power line contacts 12, and spring 3 for the retractable movement of the prongs receiving member 1. The fitting and guiding portions control the retractable movement of the prongs receiving member 1 relative to power line contacts 12. The fitting ad guiding portions comprise a set of fitting spigots 4 and a set of fitting spigots 10 receiving cavities located on the base member 5 which cooperate with respective mounting ears 11 and fitting spigots 10 located on the central member 1.

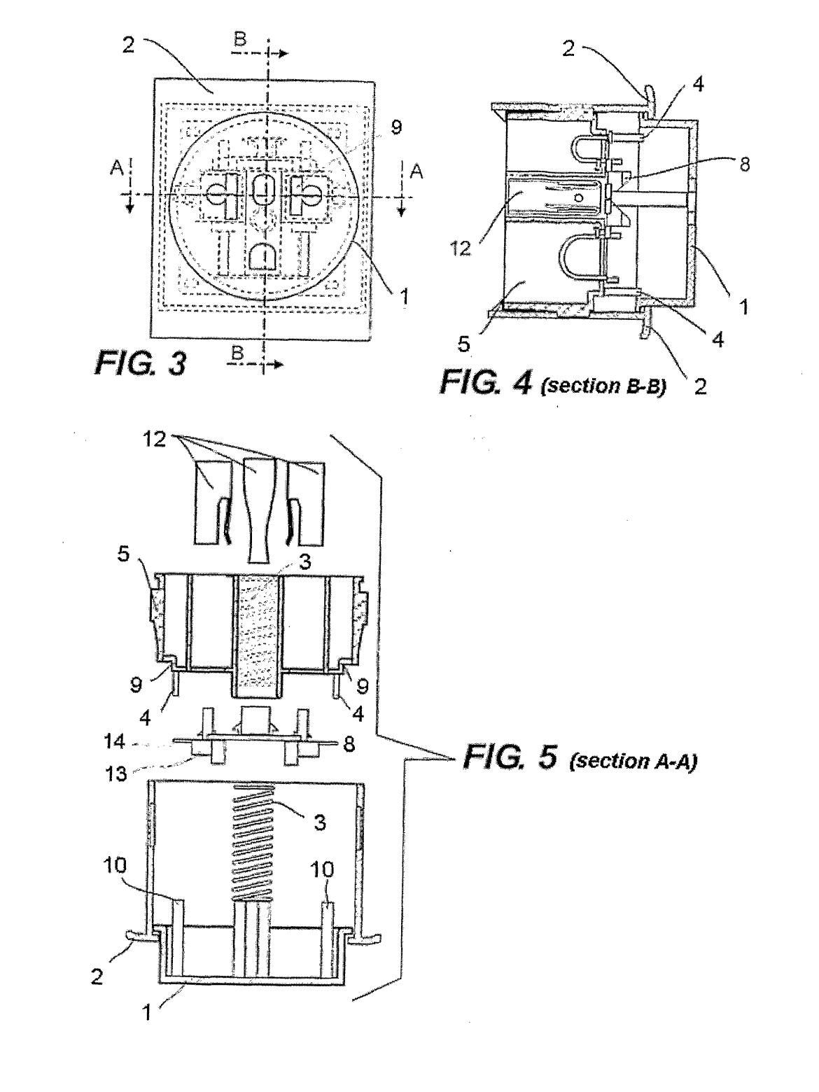

FIG. 3 shows a conventional design of the prongs receiving central member 1 and cover plate 2 and in phantom lines the hidden internal components of the electrical socket device of the invention. The prongs receiving member 1 is of circular shape, similar to a cup and protrudes through cover plate 2 however other parallelepiped shapes and sizes can be used for different models. Furthermore, the prongs receiving central member 1 may include prongs receiving apertures of any desired shape and distribution. The prong receiving apertures can also be constituted by interchangeable parts disposed on central member 1. Irrespective of the external configuration the electrical socket device according to the invention will include a movable member which with simple adaptations will be mounted in conventional outlet housing and engaged by an appliance plug of the type that is used, by way of example, to connect electrical adapters, home appliances, devices, filter strips, stabilizers, no-breaks and the like.

The cross-sectional side view in FIG. 4 shows the members of the exploded view of FIG. 2 mounted together. Central member 1 is cup-shaped and protrudes through an opening on the front side of casing 2 to a controlled height. In functional terms, the appliance plug 7 receiving member 1 is a transiting member, which mechanically commutates electrical conduction and non-conduction states on the basis of its insertion depth or of the appliance plug 7. The appliance plug receiving member 1 prevents the occurrence of electric conduction when the appliance plug 7 is not completely pushed into the electric outlet, e.g. when sections of the prongs remain exposed thereby protecting users against electric shocks that arise by an inadvertent finger touch with the prongs or by the insertion of a metal piece by a child in the outlet socket.

As depicted in FIG. 5, the prongs receiving member or cup 1 is a follower member moved by an appliance plug 7 against the spring force of spring 3 through the front plate of casing 2 towards the base member 5. To that end prongs 6 pass through the receiving apertures 9 and abut against mutually opposing stopper portions 13, 14 on both side of a groove and located by pairs on longitudinal opposed distal ends of the auxiliary barrier member 8 mounted on base member 5. Auxiliary barrier member 8 is of resilient material. First and second pairs of mutually opposite stopper portions 13, 14 adjacently located to said groove on longitudinal opposed distal ends define respective groove accesses which communicate to the fitting spigot receiving cavities 9 and power line contacts 12 located on base member 5.

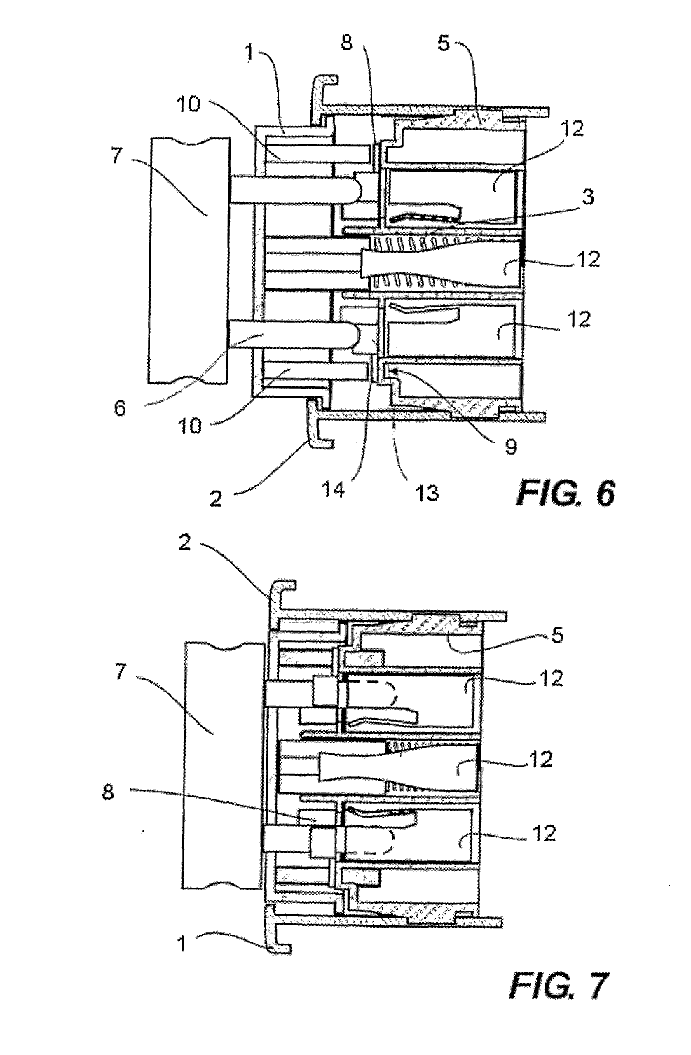

FIG. 6 shows the hidden components in a cut-away portion. The appliance plug 7 is stopped during partial depth insertion in the prongs receiving central member 1 which protrudes through the opening on the front plate of casing 2 and biased by spring 3. Fitting spigots 10 and the tips of the prongs 6 are in abutment to stopper portions 13, 14 of respective groove accesses located on the auxiliary barrier member 8. Since the auxiliary barrier member 8 is made of a non conductive material the prongs section that remain exposed are not energized despite the fact of being received in the prongs receiving apertures 9.

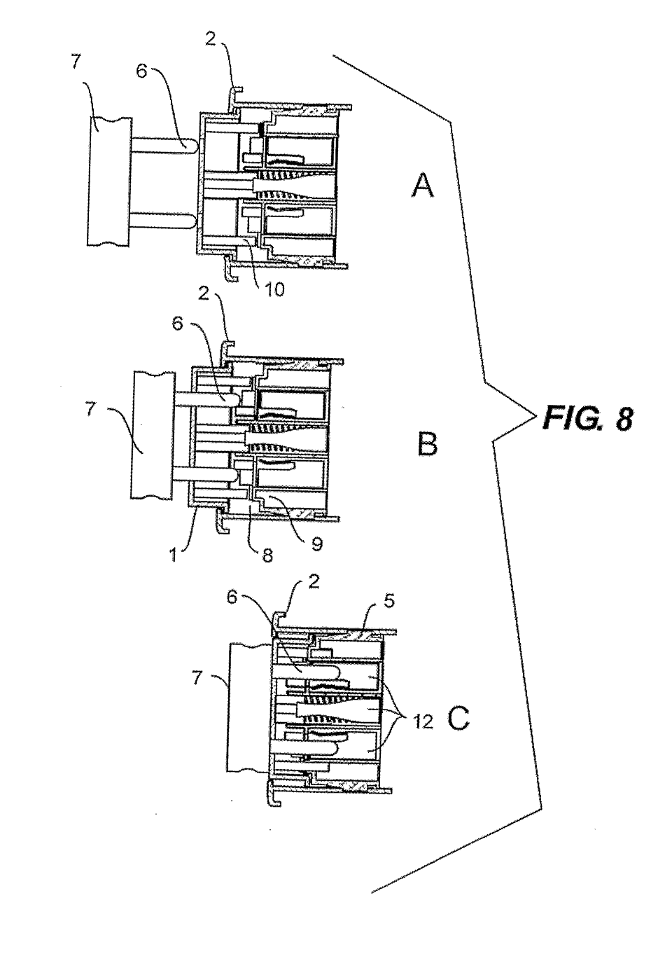

FIG. 7 and the orthographic drawing of FIG. 8 show initial, intermediate and final engagement of the appliance plug 7 to power line contacts once the prongs receiving member 1 has reached full depth insertion in casing 2. On pushing appliance plug 7 to full depth insertion, the fitting spigots 10 on the prongs receiving member 1 pass through the groove access which is normally closed by stopper portions 14 thereby causing the passage of prongs 6 through the groove access normally closed by mutual converging stopper portions 13 and finally engaging power line electric contacts 12.

Conversely, during the unplugging step the central member or cup 1 is impelled by spring 3 to return to its initial protruded position until the mounting ears 11 abut against an inner counteredge region defining the opening on the front plate of casing 2. Spring 3 is normally a cylindrical spring but any other forms of springs and spring loaded means providing for a spring loaded reciprocal movement of the prongs receiving member 1 could be used without major adaptations. Accordingly the prongs receiving member 1 carrying the appliance plug 7 commutates from the conduction state to the non conduction state first before exposing a section of the prongs 6.

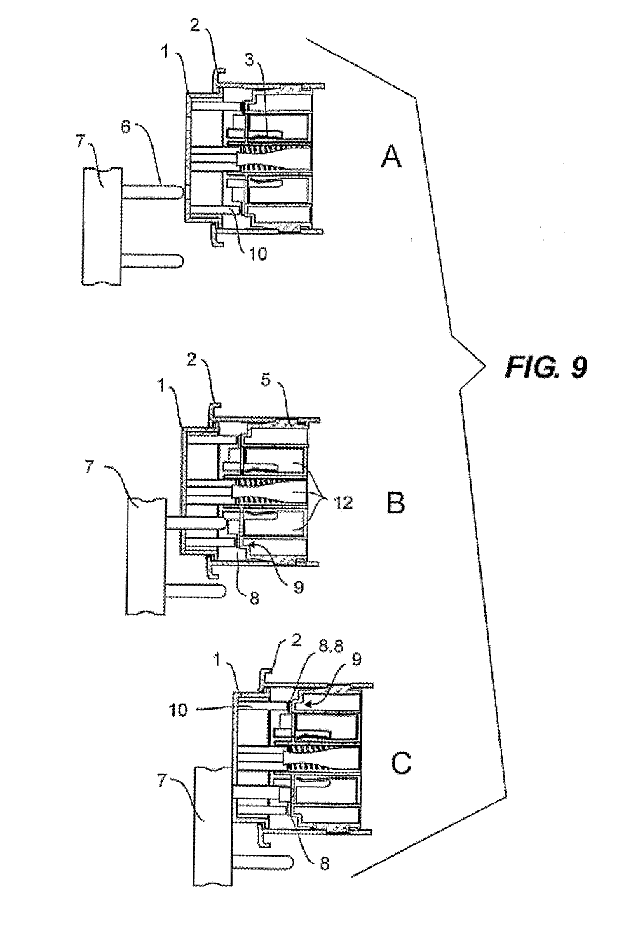

The orthographic drawing of FIG. 9 shows an example of a single pole insertion with one of the prongs creating a risk situation due to a possible touch with a fully exposed prong and that is avoided by the electrical socket device of the present invention. The material properties and configuration of the prongs receiving member 1 are such that the force of one of the two fitting spigots 10 acting on stopper portions 14 located on one of the longitudinal opposite distal ends of the barrier member 8 is not enough to open the normally closed groove access thereby preventing any engagement of the prong with the power line contact 12.

During the plugging and unplugging operation with the electrical socket device of the invention the exposed sections of the prongs 6 are electrically isolated through the prongs receiving member 1 thereby protecting fingers and as derived from FIG. 9 the single pole engagement with a pin shaped metallic object is obstructed.

The stroke of the prongs receiving member 1 is substantially equivalent to the gap between the inner counteredge region and the base member 5 and is obtained by the passage of a respective fitting spigot through the groove access controlling portions 14 on longitudinal opposite distal ends of the auxiliary barrier member 8.

The length by which the prongs receiving member 1 protrudes through the front plate of casing 2 may vary up to about 50% and preferably not less than 40% of the length of a prong or blade 6 of an appliance plug 7. The spring force varies between 1,1 N and 3 N. Furthermore, to protect the present arrangement against any disequilibrium that may arise by the forces acting on the movable members fitting spigots 4 are provided with ridges along its length.

The invention is not limited to the embodiment which has been described and illustrated by way of example and numerous modifications and variations can be proposed without departing from the scope of the appended claims.

1. An electrical socket device comprising:
a casing,
electrical contact members for operative connection to an electrical power line,
a front plate, and
a prongs receiving member for fitting a plug on said socket device, said prongs receiving member being spring loaded and extending through said front plate to an outmost position away from said front plate and in abutment with a traversable barrier member located within said casing,
wherein said prongs receiving member is a plug follower member when engaged by said plug for reciprocating movement between said outmost position at which conductive portions of the prongs of said plug fitted in the electrical socket are partially exposed without carrying current and a final inwardly position at which said plug is operatively connected to said electrical contact members through said traversable barrier element thereby preventing the occurrence of an electric shock made by direct contact by the user when the plug is being inserted into or withdrawn from the electrical socket.

2. The electrical socket device of claim 1, wherein said prongs receiving member at said outmost position is free from any electricity conduction members.

3. The electrical socket device of claim 1, wherein said electrical contact members for operative connection to the electrical power line are housed within said casing.

4. The electrical socket device of claim 1, wherein said prongs receiving member at said outmost position and said electrical contact members are electrically isolated by said traversable barrier element located therebetween.

5. The electrical socket device of claim 1, wherein said prongs receiving member rides up said electrical contact members when traveling from said outmost position to said inwardly position.

6. The electrical socket device of claim 1, wherein the length or stroke by which said prongs receiving member protrudes through the front plate may vary up to about 50% and not less than about 40% of the length of the prong of the plug.

7. The electrical socket device of claim 1 wherein said prongs receiving member is biased towards the outmost position by a cylindrical spring element.

8. The electrical socket device of claim 1, wherein the spring force varies between 1.1 N and 3 N.

9. A method of using an electrical socket device as defined in claim 1 for the connection of home appliances, electrical adapters, filter strips, stabilizers, or no-breaks.

10. The electrical socket device of claim 3, wherein said prongs receiving member at said outmost position and said electrical contact members are electrically isolated by said traversable barrier element located therebetween.

11. The electrical socket device of claim 4, wherein said prongs receiving member rides up said electrical contact members when traveling from said outmost position to said inwardly position.

12. The electrical socket device of claim 5, wherein the length or stroke by which said prongs receiving member protrudes through the front plate may vary up to about 50% and not less than about 40% of the length of the prong of the plug.

13. The electrical socket device of claim 7, wherein the spring force varies between 1.1 N and 3 N.
